(19) United States
(12) Patent Application Publication
(10) Pub. No.: US 2015/0037124 A1
(43) Pub. Date: Feb. 5, 2015

(54) APPARATUS FOR TIPPING CONTAINERS OR MOVABLE CASES

(71) Applicant: Bruno Longagna, Cengio (SV) (IT)

(72) Inventor: Bruno Longagna, Cengio (SV) (IT)

(21) Appl. No.: 14/353,881

(22) PCT Filed: Jul. 19, 2012
(86) PCT No.: PCT/EP2012/064206

§ 371 Date: Jul. 23, 2014

(30) Foreign Application Priority Data
Jul. 21, 2011 (IT) MI2011A001361
Nov. 29, 2011 (IT) MI2011A002173

(51) Int. Cl. B65D 88/56; B66C 1/10

(52) U.S. Cl. CPC B65D 88/56; B66C 1/101
USPC 414/425

(57) ABSTRACT

An apparatus for coupling and tipping in air a container or a movable case to unload its contents is described. Said apparatus comprises an upper frame coupled to lifting means and a lower frame coupled to a container, where the two frames are connected to each other by hinges at one end, and by a piston device at the other end, the piston device being capable of separating the two frames by a given angle between a closed resting position and an open working position.

The present invention relates to an apparatus for tipping containers and movable cases.

Methods for tipping containers and movable cases containing loose materials of all kinds are known. The containers or movable cases are normally unloaded from means of transport, such as trucks, railway cars or ships, by means of cranes. The crane is normally provided with a frame of the same size as the container or movable case. This frame is provided with four hydraulic pistons capable of introducing and turning four twist-lock type coupling means within specific slots of the containers and movable cases. Once the twist locks are connected and coupled to the container or movable case, the latter are lifted and moved to the ground or to other means of transport. The twist locks are released and only afterwards the containers or movable cases containing loose materials are moved and positioned onto particular apparatuses resting on the ground which are capable of tipping them and appropriately unloading their contents. It is not currently possible to grip containers or movable cases and directly unload their contents onto another means of transport before having carried out the above-described intermediate steps, which causes wasting of time.

It is the object of the present invention is to provide an apparatus for coupling containers or movable cases and directly unloading their contents without needing intermediate steps, thus considerably reducing the time from the process and facilitating it by decreasing the number of operations.

In accordance with the present invention, such an object is achieved by an apparatus for coupling and tipping in air a container or a movable case in order to unload its contents, characterized in that it comprises an upper frame coupled to lifting means and a lower frame coupled to a container, where the two frames are connected to each other by means of hinges at one end and by means of a piston device at the other end, the piston device being capable of separating the two frames by a given angle between a closed resting position and an open working position.

An advantage of the present invention is to shorten the time needed to unload the contents from a container or movable case, thus eliminating the intermediate steps and decreasing the number of operations needed to complete the process.

These and other features of the present invention will become more apparent from the following detailed description of a practical embodiment thereof, shown by way of non-limitative example in the accompanying drawings, in which:

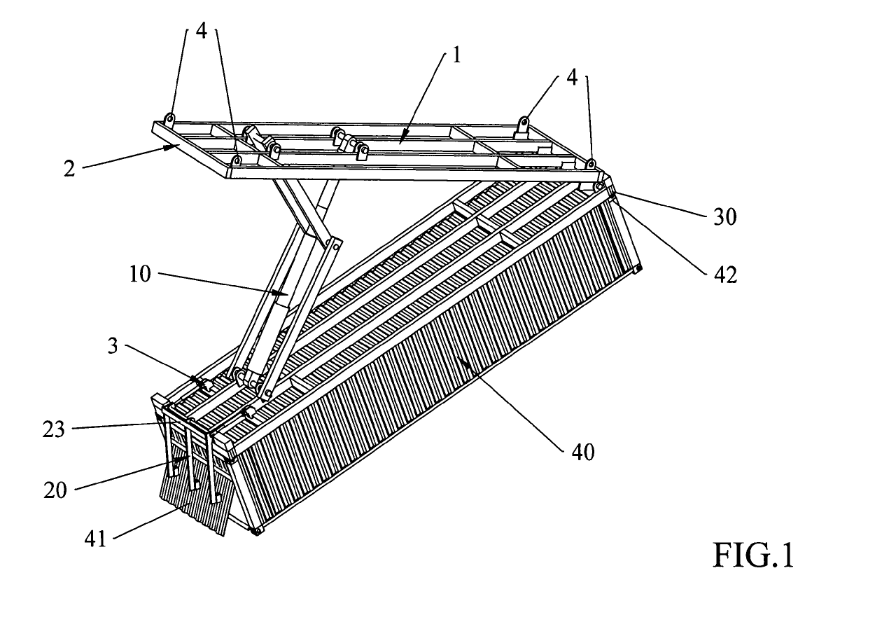

FIG. 1 shows a perspective view of a double-frame apparatus with a separating piston device in working position coupled to a container;

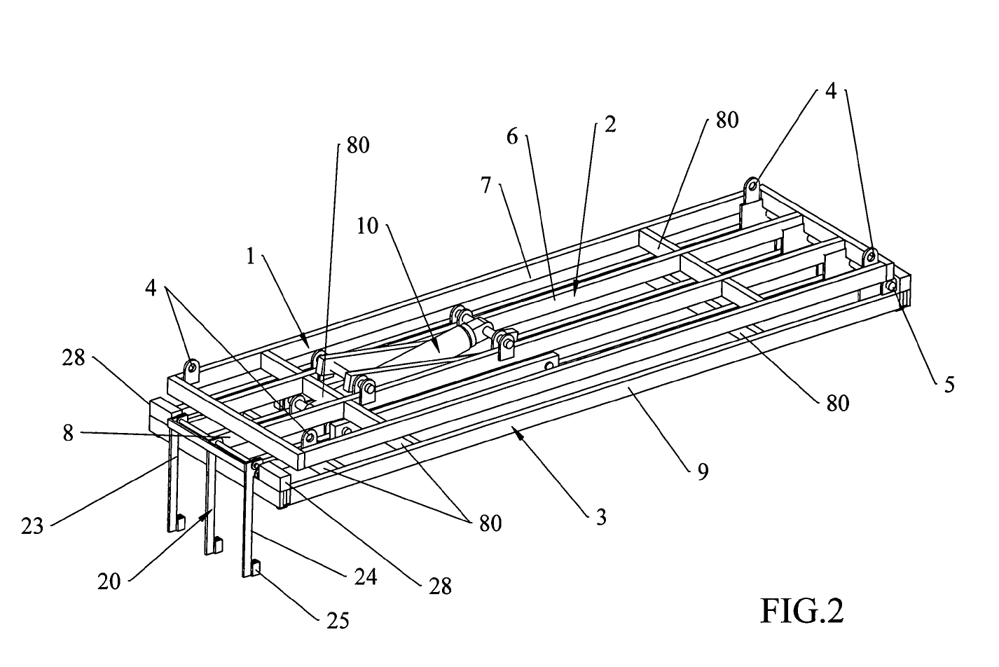

FIG. 2 shows a perspective view of a double-frame apparatus with a separating piston device in resting position;

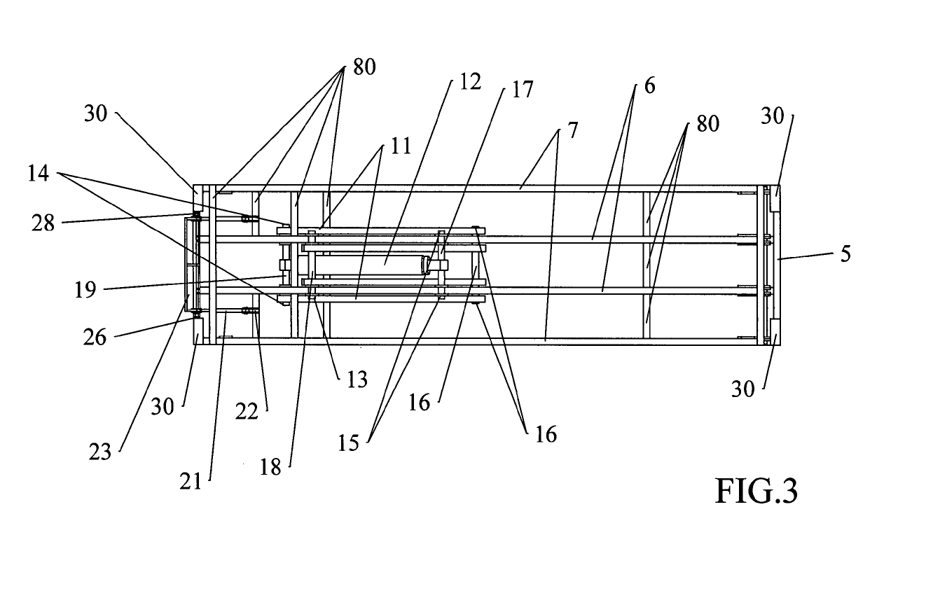

FIG. 3 shows a top plan view of a double-frame apparatus including a separating piston device in resting position;

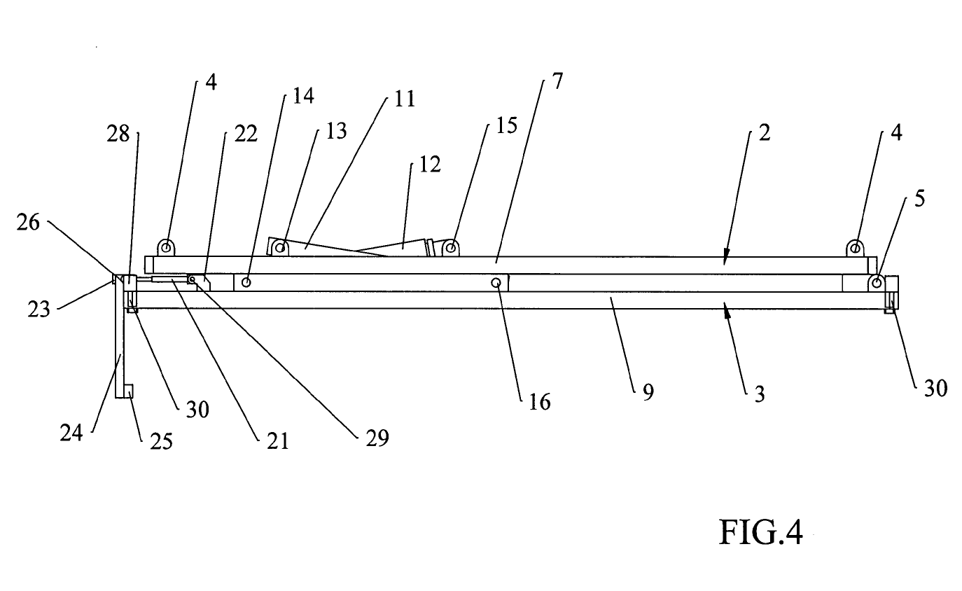

FIG. 4 shows a side view of a double-frame apparatus in resting position;

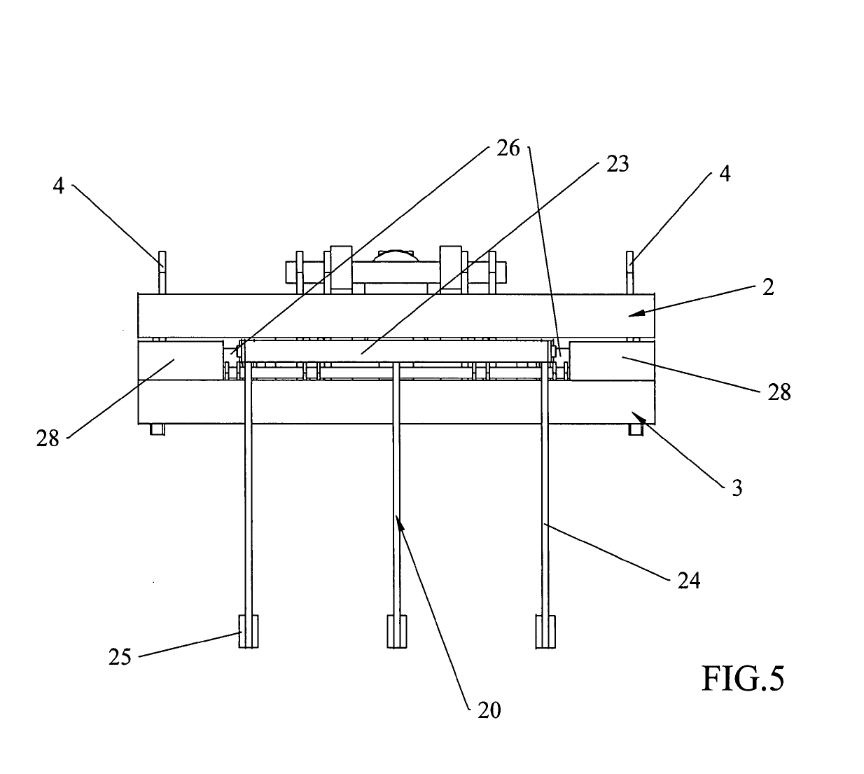

FIG. 5 shows a front view of a double-frame apparatus in resting position;

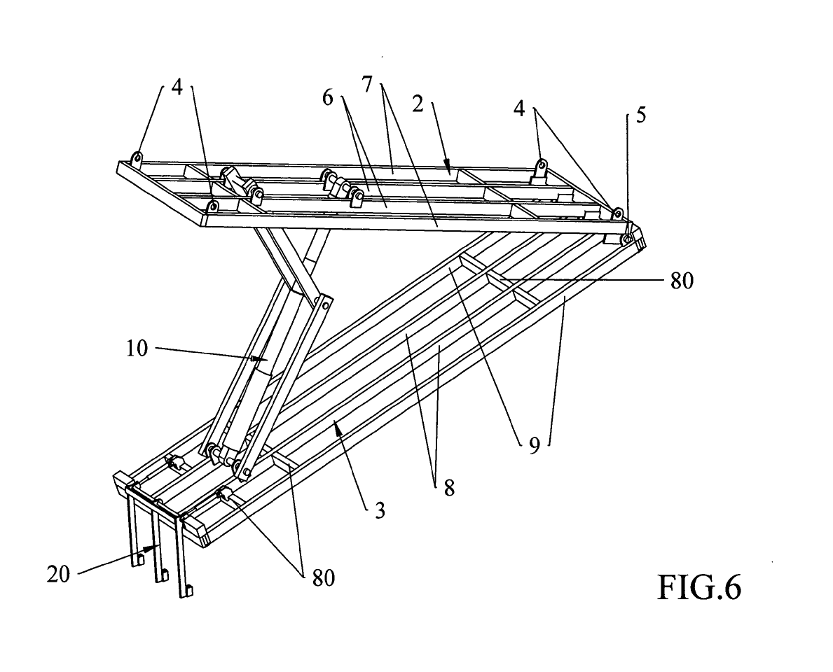

FIG. 6 shows a perspective view of a double-frame apparatus with a separating piston device in working position without container;

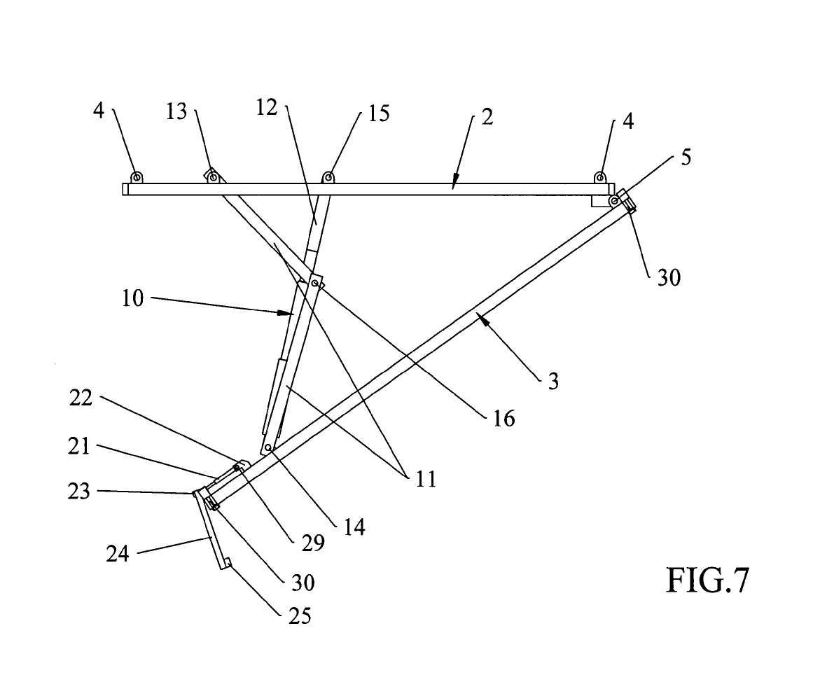

FIG. 7 shows a side view of a double-frame apparatus with a separating piston device in working position;

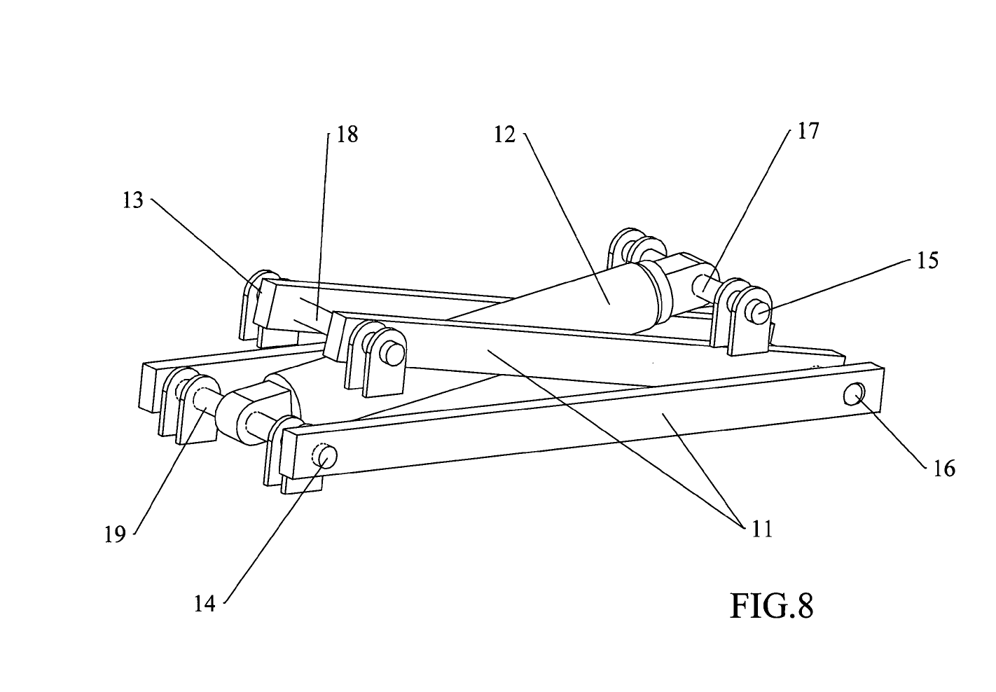

FIG. 8 shows a perspective view of a separating piston device in resting position;

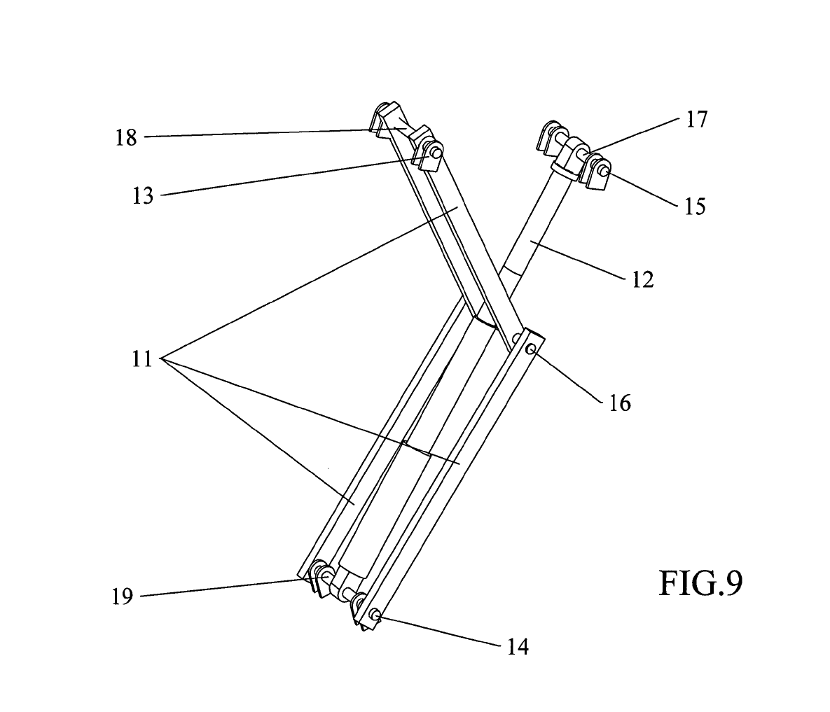

FIG. 9 shows a perspective view of a separating piston device in working position.

The above-listed figures show a double-frame apparatus 1 comprising an upper, substantially rectangular frame 2 with side stringer section bars 7 of length comparable to that of a container or movable case 40. Other two central section bars 6 spaced from the crosswise section bars 80 are welded within the upper frame 2, parallel to the longer length, said crosswise section bars 80 also spacing said central section bars 6 apart from said side section bars 7.

Four rings (eyebolts) 4 are welded to the corners of the upper frame 2 to be possibly coupled to lifting means by means of ropes or chains 70. Two hinges 5, which connect a lower frame 3 of the same size and features as the upper frame 2, are mounted to one end of the short side of the upper frame 2. Two pairs of rings 13, 15, the function of which will be more apparent below, are welded to the central section bars 6. The lower frame 3 includes two side section bars 9 and two central section bars 8 spaced apart by the crosswise section bars 80.

The two central section bars 6 of the upper frame 2 may contain two additional section bars 35 of slightly smaller size adapted to extend towards the outside of frame 2 in the direction opposite to that of hinge 5, so as to form a rail on which a counterweight 36 may run. A pair of rings 14 welded onto the central section bars 8, the function of which will be more apparent below, is present in the same half of the lower frame 3.

Four coupling means 30 of the twist-lock type, respectively actuated by four hydraulic pistons 31 accommodated in the space between the upper frame 2 and the lower frame 3, are located at the four corners of the lower frame 3. These twist locks 30 allow a container 40 to be coupled by means of a linkage which rotates four T-shaped pistons 32 into specific insertion holes 42 present on the containers 40.

A hydraulic piston device 12 is connected to the lower frame 3 by means of a pin 19 rotationally associated with two rings 14 integral with the two central section bars 8 of the lower frame 3. The other end of the hydraulic piston 12 is connected to the upper frame 2 by means of a pin 17, rotationally associated with the pair of rings 15.

When the hydraulic piston 12 switches from a resting position to a working position, the two frames 2, 3 are advantageously separated by any angle, by rotating on the pivot identified by the hinges 5. The hydraulic piston 12 is advantageously protected from excessive extension by two pairs of rods 11 hinged to each other by means of two pins 16 to form a connecting rod. The two rods 11 are connected to the lower frame 3 on the same pin 19 rotationally associated with the same rings 14 of the hydraulic piston 12. The two rods 11 are connected to the upper frame 2 by means of another pin 18 rotationally associated with the two rings 13 of the upper frame 2 itself.

An advantageous linkage system 20 actuated by two hydraulic pistons 21 is mounted to the short side of the lower frame 3 in a direction opposite to hinge 5. One end of the hydraulic pistons 21 is connected to pins 29 rotationally inserted into two rings 22 welded to the crosswise section bars 80 of the lower frame 3. A pin 26 rotationally mounted to two rings 28, welded in turn to the ends of the lower frame 3, is connected to the other end of the hydraulic pistons 21.

A section bar 23, to which section bar three section bars 24 are mounted, is found on the pin 26, three rubber pads 25 being mounted to the section bars 24 in the direction of the container 40. When the hydraulic pistons 21 are in the resting position, the rubber pads 25 advantageously keep the pivoting door 41 of container 40 closed. When the hydraulic pistons 21 switch to a working position, they advantageously rotate the section bar 23 on pin 26. The section bars 24 are pushed outwards, thus opening the pivoting door 41 of the inclined container 40 by gravity (FIG. 1).

A hydraulic circuit 37 required to actuate the linkages is present on the double frame 1 and comprises cut-off valves 38, pipes 39 and blocks 43 positioned on the two frames 2, 3.

In order to couple a container or a movable case 40 and tip it to unload its contents, the double-frame apparatus 1 is advantageously mounted to a lifting means, such as a hoist or a crane, which is provided with a suitable, advantageous system of levers and counterweights to preserve the mechanical moment (torque).

The double-frame apparatus 1 is coupled by means of the four twist locks 30 actuated by the hydraulic piston system 31. The twist locks 30 rotate the four T-shaped pistons 32 which penetrate into the four holes 42 of container 40 until coupling occurs.

The lifting means to which this apparatus 1 is mounted lifts and moves the container or movable case 40 keeping it advantageously parallel to the ground, as it normally occurs.

Two ropes or chains 70 are connected to the four rings 4 and to a crane hook 71 (not shown). Four rigid rods 75 (not shown) may be used alternatively to the system of ropes and chains 70. Once the unloading position of the contents of container 40 has been reached, piston 12 is operated so that the two frames 2, 3 are advantageously separated by an appropriate angle in order to advantageously fall the contents by gravity.

In the case of the above-described counterweight system, the upper frame 2 may be kept advantageously parallel to the ground, while piston 12 starts moving, while extending the two profiles 35 outwards from the two central profiles 6 to advantageously act as arms along which the counterweight 36 to be placed at the appropriate distance to preserve the mechanical moment in all instants may run.

Alternatively, two crane hooks 71, 72, mounted to two self-standing pulley systems 73, 74, respectively, may be used. The first hook 71 is connected by means of the rope or chain 70 to the two rings 4 positioned on the short side of the upper frame 2 without hinges 5. The other hook 72 is connected by means of the rope or chain 70 to the two other rings 4 positioned on the short side of the upper frame 2 on the side of the two hinges 5. Here, the mechanical moment is preserved by advantageously lifting the hook 71 and granting clearance to the hook 72, while the piston 12 extends and switches to the working position. In this case, the upper frame 2 will not remain parallel to the ground and the piston 12 must space the two frames 2, 3 to a greater extent from each other than in the procedure described above, in order to advantageously reach the appropriate angle for unloading the contents of container or movable case 40.

Alternatively, the upper frame 2 may be connected without hooks to a lifting arm of a crane so that the mechanical moment (torque) is balanced by counterweights and rods connected to the ground.

Once the lower frame 3 has reached an angle deemed sufficient to unload the contents of container or movable case 40, the pistons 21 are actuated by means of a linkage system to open the pivoting door 41 of container 40 and advantageously pour its contents into an appropriate place.

The above-described double-frame apparatus 1 thus allows to unload the contents of a container 40 with a single piece of equipment, thus advantageously reducing the working time.

1. An apparatus for coupling and tipping in air a container or a moveable case in order to unload its content, wherein it comprises an upper frame coupled to lifting means and a lower frame coupled to a container, wherein the two frames are connected to each other by means of hinges at one end and by means of a piston device at the other end, the piston device being capable of separating the two frames by a given angle between a closed resting position and an open working position.

2. The apparatus according to claim 1, wherein the piston device comprises a piston and two pairs of rods hinged to each other to form a connecting rod, said piston device being connected to the two frames and capable of spacing them apart by a suitable angle, the vertex of which coincides with the center of the hinges.

3. The apparatus according to claim 1, wherein the upper and lower frames are formed by stringer section bars spaced apart by crosswise section bars.

4. The apparatus according to claim 2, wherein one end of the piston is connected to the lower frame by means of a pin rotationally associated with two rings welded to two central section bars of the lower frame, while the other end of the piston is connected to the upper frame by means of a pin rotationally associated with a pair of rings welded to central section bars of the upper frame.

5. The apparatus according to claim 1, wherein it comprises opening means of a pivoting door of a container at one end of the lower frame opposite to the end of the hinges.

6. The apparatus according to claim 5, wherein said opening means comprise hydraulic pistons connected to the lower frame and a section bar to which three section bars provided with rubber pads adapted to open and close a pivoting door of a container are mounted.

7. The apparatus according to claim 1, wherein it comprises a coupling system for a container or a moveable case by means of four coupling means provided with hydraulic pistons mounted to the four corners of a lower frame.

8. The apparatus according to claim 1, wherein the upper frame includes section bars extending outwards so that a counterweight run thereon.
